(19) United States
(12) Patent Application Publication
(10) Pub. No.: US 2007/0080237 A1
(43) Pub. Date: Apr. 12, 2007

(54) Motor vehicle heating device comprising an additional heater

(75) Inventors: Roland Burk, Stuttgart (DE); Jurgen Otto, Illingen (DE); Matthias Traub, Korntal-Munich (DE); Mathieu Mougey, Ensisheim (DE)

Correspondence Address: FOLEY AND LARDNER LLP;SUITE 500, 3000 K STREET NW, WASHINGTON, DC, 20007, US

(73) Assignee: BEHR FRANCE S.A.R.L., STUTTGART GERMANY (DE)

(21) Appl. No.: 10/577,161

(22) PCT Filed: Sep. 15, 2004
(86) PCT No.: PCT/EP04/10314

§ 371 Date: Sep. 6, 2006

(30) Foreign Application Priority Data
Oct. 27, 2003 (JP) 03292678.4

(51) Int. Cl. B60H 1/00; B61D 27/00

(52) U.S. Cl. 237/28

(57) ABSTRACT

The invention relates to a heating device of a motor vehicle comprising an internal combustion engine (2) and a vehicle interior. Said heating device encompasses a cooling circuit (1) for cooling the internal combustion engine (2), a heating circuit (6) that is provided with at least one heating element (7) and is used for heating the vehicle interior, and an additional electric heater, especially an auxiliary PTC heating unit (8). According to the invention, a heat source can be connected to the cooling circuit and/or the heating circuit (6) as a second supplementary heater (9).

The invention relates to a heating apparatus for a motor vehicle which has an internal combustion engine and a vehicle interior, as claimed in the precharacterizing clause of patent claim 1.

Motor vehicles whose engine consumptions are optimized require an additional heater in order to provide sufficient heating power for the vehicle interior, owing to the lack of exhaust heat from the engine. There are very widely differing embodiments of additional heaters such as these. So-called integrated electrical additional heaters are known from DE-A 44 33 814 and EP-B 707 434 from the same applicant, or from DE-A 198 11 629, in which heating elements which can be heated electrically, in particular PTC elements, are integrated in the heating body of a heating system. The electrical energy is drawn from the motor vehicle electrical power supply system, and the heating elements pass their heat directly to the air flowing into the vehicle interior and/or additionally to the coolant which flows through the heating body. A further type of PTC additional heater is known from DE-A 199 11 547 from the same applicant and from DE-A 199 57 452, specifically, a so-called heating register with PTC elements which is attached as an additional part to a heating body of a heating system.

These electrical additional heaters act primarily on the air and thus develop their heating effect relatively quickly. On the other hand, they load the vehicle electrical power supply system and their power is thus restricted. Furthermore, their power falls as the coolant temperatures rise.

So-called exhaust-gas additional heaters are known from DE-A 199 62 863 from the same applicant and DE-C 32 25 373, in which the exhaust gas from the internal combustion engine is applied to the primary of an exhaust-gas heat exchanger, and the coolant in the heating circuit is applied to its secondary. The engine exhaust heat in the exhaust gas is thus transferred to the coolant and is transported to the heating body in the heating system, in order to heat the air there for the vehicle interior. The exhaust-gas heating thus has more inertia than the electrical additional heater and has little heating power during cold starting, although this rises as the time for which the motor vehicle has been driven increases.

So-called visco heaters are known from DE-A 38 32 966, DE-A 44 20 841 and U.S. Pat. No. 4,993,377, which convert mechanical energy from the internal combustion engine to heat by means of liquid friction, and emit this heat via a cooling jacket to the coolant in the cooling circuit of the internal combustion engine, or the heating circuit. When required, for example during cold starting, the visco heating can be connected via a clutch, and thus produces heat immediately, which is supplied to the heating body in the heating system via the coolant. Since it acts indirectly via the coolant, this visco heating thus also has a relatively large amount of inertia and produces little additional heating power, particularly at idle. Visco heating has advantages in the case of a large proportion of cross-country journeys, that is to say at relatively high engine rotation speeds over a relatively long time.

A further type of additional heater is known from DE-A 44 35 693, specifically a fuel heater, in which the heat is obtained by combustion of fuel. A fuel gas/coolant heat exchanger is required for this purpose, and transfers the combustion heat to the coolant. This additional heating also has a relatively large amount of inertia owing to the indirect heat transfer via the coolant to the air which is supplied to the vehicle interior. On the other hand, it is independent of the engine, but is associated with a relatively large amount of hardware complexity (burner and specific heat exchanger).

None of the abovementioned additional heaters can thus completely cover the requirement profile, particularly as future engine development will continue further in the direction of low-consumption engines, that is to say engines with high efficiency and little exhaust heat.

The object of the present invention is thus to improve a heating apparatus of the type mentioned initially such that it provides adequate heating power over a wide operating range of the motor vehicle.

This object is achieved by the features of patent claim 1. According to the invention, a second additional heater is provided and is combined with the first additional heater, that is to say with the electrical or PTC heater. The second additional heater draws its energy from a heat source which is not fed from the vehicle electrical power supply system. No further load is thus applied to the vehicle electrical power supply system. In addition, this combination of two different additional heaters results in the advantage that a wider operating range of the motor vehicle is covered, and drawbacks resulting from, for example, an electrical additional heater are compensated for by advantages of the other, non-electrical additional heating.

According to one advantageous refinement of the invention, the second additional heater is in the form of an exhaust-gas heater, in which the exhaust heat from the exhaust gases is transferred by means of an exhaust-gas heat exchanger to the coolant in the heating circuit. This combination has the advantage, inter alia, that the heating “responds” relatively quickly, because the PTC heater heats the air very quickly. After this “starting phase”, the exhaust-gas heating becomes increasingly significant. The PTC heater can now be switched off or turned down.

According to a further advantageous refinement of the invention, a so-called visco heater is provided for the second additional heater, that is to say a liquid friction clutch which is driven by the engine—and if required can be connected via a clutch—which emits the heat produced by it by means of liquid friction via a cooling casing to the coolant in the heating circuit. The friction heat is thus passed to the heating body, which heats the air. The visco heater is thus arranged upstream of the heating body in the heating circuit, that is to say in the input to the heating body. This combination results in the advantage that the operating range of the additional heater is likewise extended, since the two types of heater complement one another. The PTC heater provides rapid heating during cold starting, while the visco heater provides improved heating power during cross-country journeys.

In a further advantageous refinement of the invention, a fuel heater is provided as the second additional heater and operates independently of the engine, since it draws the thermal energy from the combustion of fuel. The combustion gases emit their heat via a heat exchanger to the coolant, which heats the heating body and thus the air. The fuel heater is highly effective as an additional heater—after a starting phase which is once again bridged by the PTC heater—and its power is controllable.

In summary, the abovementioned combinations of two additional heaters result in improved reliability (redundancy), improved heating and better comfort in the widely differing driving states.

Exemplary embodiments of the invention will be explained in more detail in the following text and are illustrated in the drawing, in which:

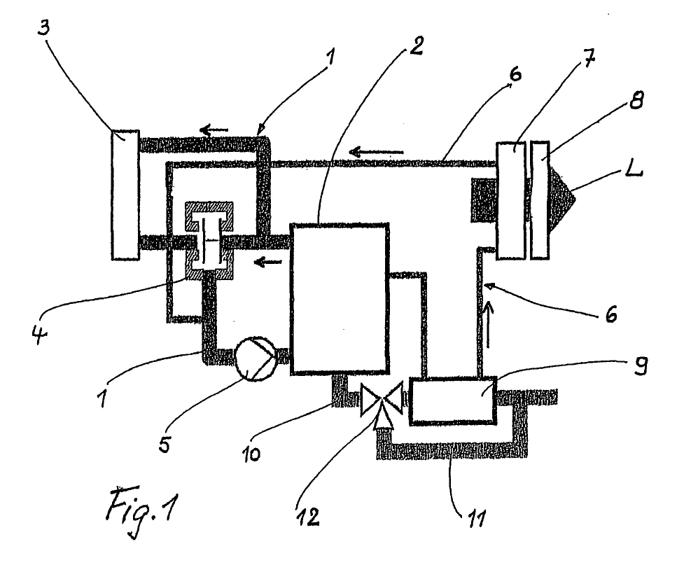

FIG. 1 shows a combination of a PTC and exhaust-gas heater, and

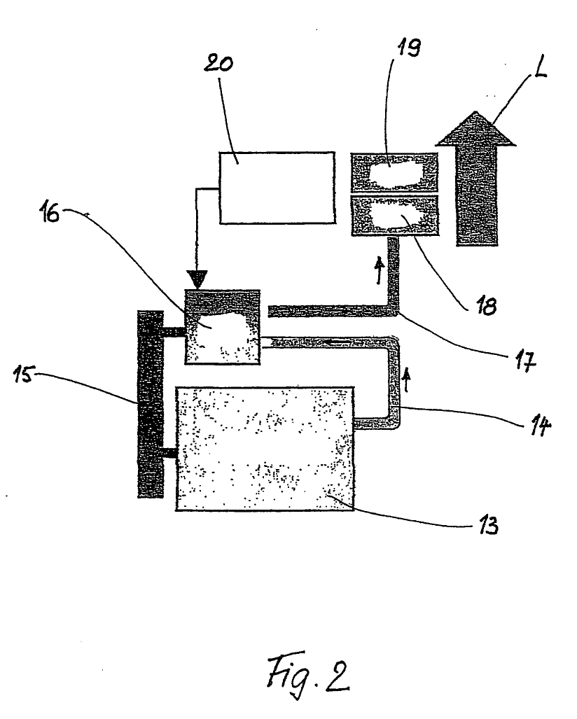

FIG. 2 shows a combination of a PTC and visco heater.

FIG. 1 shows a cooling circuit 1 for an internal combustion engine 2 in a motor vehicle, which is not illustrated. A coolant cooler 3, a thermostat 4 and a coolant pump 5 are arranged in the cooling circuit 1. A heating circuit 6 is connected to the cooling circuit 1, in which heating circuit 6 a heating body 7 and a PTC additional heater 8 as well as an exhaust-gas heat exchanger 9 are arranged. Air flows through the heating body 7 and the PTC additional heater 8, indicated by an arrow L, and is supplied to the interior of a motor vehicle, which is not illustrated. The exhaust-gas heat exchanger 9 is connected to an exhaust-gas line 10 originating from the engine 2, and exhaust gas flows through its primary. The exhaust-gas heat exchanger 9 can be bypassed by means of a bypass line 11, which can be connected or disconnected by an exhaust-gas valve 12.

The two additional heaters operate as follows: the vehicle interior is heated by the airflow L, which passes the heating body 7 and the PTC additional heater 8. The PTC additional heater 8 can be switched on when required, for example during cold starting of the engine 2, and then directly heats the airflow L, which leads to relatively rapid heating. The exhaust-gas heat exchanger 9 or exhaust-gas heater is connected via the exhaust-gas valve 12 by blocking the bypass 11 and by the exhaust gas flowing through the exhaust-gas heat exchanger 9. The coolant that has been heated in this way is then passed via the heating circuit 6 directly to the heating body 7, which thus receives heated coolant at a relatively early stage. The heating power of the heating body 7 is thus increased. The two additional heaters, that is to say both the PTC heater 8 and the exhaust-gas heater 9, can be switched off together or separately, with the exhaust-gas heat exchanger 9 being switched off by diverting the exhaust gases via the bypass 11.

FIG. 2 shows a further exemplary embodiment of the invention, to be precise with a combination of a PTC and a visco additional heater. An internal combustion engine 13 has a cooling circuit 14 (illustrated in a simplified form) and a coolant cooler 15. A visco heater 16 is connected in the engine return or the cooler input of the cooling circuit 14 and is connected to a heating body 18 via a coolant line 17 in a heating circuit, which is not illustrated in its entirety. An airflow passes through the heating body 18 and a PTC additional heater 19, represented by an arrow L, and is passed to the interior of a motor vehicle, which is not illustrated. The so-called visco heater 16 is known from the prior art cited in the introduction; it can either be connected to the engine via a clutch, and can thus be switched on, or its heating power can be controlled while being permanently connected to the engine 16, for example by varying the liquid friction gap. This control of the visco heater 16 is indicated by a controller 20.

These two additional heaters operate in a similar way to that in the previous exemplary embodiment. For the rapid heating of the vehicle interior; for example during cold starting, the PTC heater 19 is switched on first of all. The visco heater 16 then becomes effective some time later by feeding hot coolant into the heating body 18. The two additional heaters can be operated independently of one another.

1. A heating apparatus for a motor vehicle which has an internal combustion engine and a vehicle interior, having a cooling circuit (2, 14) for cooling the internal combustion engine (2, 13) and having a heating circuit (6, 17), which has at least one heating body (7, 18), for heating the vehicle interior, as well as having an electrical additional heater, in particular a PTC additional heater (8, 19), characterized in that a heat source can be connected to the cooling and/or heating circuit (6; 14, 17) as the second additional heater (9, 16).

2. The heating apparatus as claimed in claim 1, characterized in that the heat source is in the form of an exhaust-gas heat exchanger (9).

3. The heating apparatus as claimed in claim 2, characterized in that the exhaust-gas heat exchanger (9) is arranged between the internal combustion engine (2) and the heating body (7) in the heating circuit (6).

4. The heating apparatus as claimed in claim 1, characterized in that the heat source is in the form of a visco heater (16).

5. The heating apparatus as claimed in claim 4, characterized in that the visco heater (16) is arranged upstream of the heating body (18) in the heating circuit (17).

6. The heating apparatus as claimed in claim 1, characterized in that the heat source is in the form of a fuel heater.
